(19) United States
(12) Patent Application Publication
(10) Pub. No.: US 2023/0331900 A1
(43) Pub. Date: Oct. 19, 2023

(54) BRANCHED RHEOLOGY MODIFIER WITH HYDROPHOBIC END-CAPPING GROUPS

(71) Applicants: Rohm and Haas Company, Collegeville, PA (US); Dow Global Technologies LLC, Midland, MI (US)

(72) Inventors: Wenqin Wang, Phoenixville, PA (US); John J. Rabasco, Allentown, PA (US); Masaki Furuya, Suginami (JP)

(21) Appl. No.: 18/028,831

(22) PCT Filed: Sep. 27, 2021
(86) PCT No.: PCT/US2021/052182

§ 371 Date: Mar. 28, 2023

Related U.S. Application Data
(63) Continuation of application No. 63/091,988, filed on Oct. 15, 2020.

(51) Int. Cl. C08G 18/48; C08G 18/08; C11D 3/37; C11D 1/72

(52) U.S. Cl. CPC C08G 18/4833; C08G 18/0852; C11D 3/3726; C11D 1/72

(57) ABSTRACT

The present invention is a composition comprising a waterborne hydrophobically modified alkylene oxide urethane thickener comprising structural units of a) a polyalkylene glycol; b) a polyisocyanate; and c) a C₁₄-C₃₀-alkyl-O—(CH₂CH₂O)ₙ—H alcohol ethoxylate capping agent. The composition of the present invention is useful as a thickener in formulations requiring high levels of surfactant, such as detergents.

### BACKGROUND OF THE INVENTION

The present invention relates to a composition comprising a branched rheology modifier with hydrophobic end-capping groups, more particularly a hydrophobically modified ethylene oxide urethane (HEUR) rheology modifier with branching in the polymer backbone and hydrophobic end-capping groups comprising long chain alkyl alkoxylates. The composition of the present invention is useful in systems that require relatively high amounts of surfactants, such as detergents.

Conventional nonionic associative rheology modifiers such as HEURs are useful as thickeners for waterborne systems, which tend to be opaque (for example, paint formulations) and require low concentrations of surfactants. However, for applications requiring clear formulations and high surfactant concentrations (at least 5 weight percent) such as shampoos, lotions, and dishwashing liquids, these HEURs are highly inefficient. The higher surfactant concentration requires an unacceptably high loading of the HEUR, which exacerbates haziness and increases cost.

Currently, the aforementioned clear formulations are thickened with anionic non-associative thickeners such as hydrophobically modified alkali swellable emulsions (HASEs). However, these non-associative thickeners are known to promote “re-soiling” in laundry detergent applications, wherein dirt dislodged from a fabric reasserts itself during a wash cycle. Accordingly, it would be advantageous in the field of detergents to find a thickener that is effective at low concentrations and does not cause a hazy appearance in the formulation.

### SUMMARY OF THE INVENTION

The present invention addresses a need in the art by providing a composition comprising a waterborne hydrophobically modified alkylene oxide urethane thickener comprising structural units of a) a polyalkylene glycol; b) a polyisocyanate; and c) a C₁₄-C₃₀-alkyl-O—(CH₂CH₂O)ₙ—H alcohol ethoxylate capping agent; wherein n is from 1 to 40. The composition of the present invention is useful as a thickener for applications requiring high surfactant levels.

### DETAILED DESCRIPTION OF THE INVENTION

The present invention is a composition comprising a waterborne hydrophobically modified alkylene oxide urethane thickener comprising structural units of a) a polyalkylene glycol; b) a polyisocyanate; and c) a C₁₄-C₃₀-alkyl-O—(CH₂CH₂O)ₙ—H alcohol ethoxylate capping agent; wherein n is from 1 to 40.

The term “structural unit” refers to the remnant of the recited compound after reaction. Thus, a structural unit of C₁₄-C₃₀-alkyl-O—(CH₂CH₂O)ₙ—H is C₁₄-C₃₀-alkyl-O—(CH₂CH₂O)ₙ—.

The term “polyalkylene glycol” refers to water-soluble polyethylene oxides, water-soluble polyethylene oxide/polypropylene oxide copolymers, and water-soluble polyethylene oxide/polybutylene oxide copolymers. Preferred water-soluble polyalkylene oxides are polyethylene oxides (i.e., polyethylene glycols), particularly polyethylene glycols having M_{w} in the range of from 4000, more preferably from 6000, and most preferably from 7000 g/mol, to 20,000, more preferably to 12,000 and most preferably to 9000 g/mol. A commercially available polyethylene glycol is CARBOWAX™ 8000 Polyethylene Glycol (PEG 8000, a trademark of The Dow Chemical Company or its Affiliate).

The term “polyisocyanate” refers to a compound with three or more isocyanate groups. Examples of polyisocyanates include triisocyanates such as isophorone diisocyanate (IPDI) isocyanurate trimer; hexamethylene diisocyanate (HDI) isocyanurate trimer; 1,3,5-triisocyanato-2-methylbenzene; and triphenylmethane-4, 4′, 4″-triisocyanate.

Preferably, the mole-to-mole ratio of structural units of the polyisocyanate, preferably the triisocyanate, to the polyalkylene glycol, preferably the polyethylene glycol, is in the range of from 0.3, more preferably from 0.5, to preferably 4.0, more preferably to 3.0.

Preferably the alcohol ethoxylate capping agent is a C₁₆-C₂₈-alkyl-O—(CH₂CH₂O)ₙ—H alcohol ethoxylate, where n is preferably in the range of from 5, more preferably from 10, more preferably from 15, and most preferably from 18, to preferably 35, more preferably to 30, more preferably to 26.

Preferably, the hydrophobically modified alkylene oxide urethane is a hydrophobically modified ethylene oxide urethane (HEUR). The HEUR can be prepared, for example, by contacting the polyethylene glycol with the capping agent, followed by contact with the polyisocyanate under reactive conditions. The HEUR can also be prepared by contacting the polyethylene glycol with the triisocyanate under reactive followed by contact with the capping agent under reactive conditions. It may be desirable to include a diisocyanate, especially in the alternative procedure, to reduce viscosity in the reactor. Accordingly, the thickener may further comprise structural units of a diisocyanate. Examples of suitable diisocyanates include 1,4-tetramethylene diisocyanate, 1,6-hexamethylene diisocyanate (HDI), 2,2,4-trimethyl-1,6-diisocyanatohexane, 1,10-decamethylene diisocyanate, 4,4′-methylenebis(isocyanatocyclohexane), 2,4′-methylenebis(isocyanatocyclohexane), 1,4-cyclohexylene diisocyanate, 1-isocyanato-3-isocyanatomethyl-3,5,5-trimethylcyclohexane (IPDI), m- and p-phenylene diisocyanate, 2,6- and 2,4-toluene diisocyanate, xylene diisocyanate, 4-chloro-1,3-phenylene diisocyanate, 4,4′-biphenylene diisocyanate, 4,4′-methylene diphenylisocyanate, 1,5-naphthylene diisocyanate, and 1,5-tetrahydronaphthylene diisocyanate.

Acceptable viscosity and clarity in a formulation requiring high surfactant demand at relatively low concentrations of a nonionic associative thickener are now achievable. For formulations containing surfactant in the range of from 5 to 20 weight percent, based on the weight of the formulation, the thickener demand is preferably in the range of from 0.5, more preferably from 1 weight percent to preferably 5, more preferably 4, and most preferably 3 weight percent, based on the weight of the formulation. It has been discovered that excellent results can be achieved with a surfactant loading in the range of from at least 5, or at least 8, or at least 10 weight percent, to 20 weight percent, based on the weight of the formulation. Examples of suitable surfactants include cationic surfactants such as quaternary ammonium salts; and nonionic surfactants such as amine oxide ethoxylates, methyl ester ethoxylates, alkyl amine alkoxylates. Another class of surfactants is represented by the formula C₅-C₂O-alkyl-O—(CH₂CH₂O)ₚ-H, where p is from 5 to 25. A subclass within this class is lauryl alcohol ethoxylate with 6 to 15 CH₂CH₂O (EO) groups, more preferably 7 to 11 EO groups.

As the following examples demonstrate, the composition of the present invention can be used efficiently in formulations with high surfactant concentrations while retaining clarity and thickening properties.

### Examples

### Example 1—Preparation of HEUR with SA-20, a Diisocyanate, and a Triisocyanate

A mixture of PEG 8000 (100 g) and toluene (400 g) were added to a vessel and dried by azeotropic distillation. The solution was cooled to 90° C., whereupon Desmodur W cycloaliphatic diisocyanate (5.42 g) and Desmodur N3600 HDI isocyanurate trimer (2.84 g) were added to the vessel. The mixture was stirred for 5 min, after which time dibutyltin dilaurate (0.21 g) was added. The mixture was stirred for 1 h, then cooled to 80° C. Ethal SA-20 emulsifier (stearyl alcohol with 20 EO groups, 44.29 g) was then added and stirring continued for 1 h. The mixture was cooled to 60° C., and the polymer was isolated in vacuo.

### Example 2—Preparation of HEUR with BA-25, a Diisocyanate, and a Triisocyanate

The preparation of Example 1 was repeated except that Ethal BA-25 emulsifier (behenyl alcohol with 25 EO groups, 56.05 g) was used instead of Ethal SA-20 emulsifier.

### Example 3—Preparation of HEUR with SA-20 and a Triisocyanate

A mixture of PEG 8000 (150 g), Ethal SA-20 emulsifier (51.33 g) and toluene (400 g) were added to a vessel and dried by azeotropic distillation. The mixture was cooled to 90° C., whereupon Desmodur N3600 HDI isocyanurate trimer (13.88 g) was added to the vessel. The mixture was stirred for 5 min, after which time dibutyltin dilaurate (0.21 g) was added. The mixture was stirred for 1 h, then cooled to 60° C. and the polymer isolated in vacuo.

### Example 4—Preparation of HEUR with BA-25 and a Triisocyanate

The procedure of Example 3 was substantially followed except that Ethal BA-25 emulsifier (64.82 g) was used instead of Ethal SA-20 emulsifier.

### Comparative Example 1—Preparation of a HEUR with a Diisocyanate and BA-25

A mixture of PEG 8000 (100 g) and toluene (400 g) were added to a vessel and dried by azeotropic distillation. The mixture was cooled to 90° C., whereupon Desmodur W (7.45 g) was added to the vessel. The mixture was stirred for 5 min, after which time dibutyltin dilaurate (0.21 g) was added. The mixture was stirred for 1 h, then cooled to 80° C. Ethal BA-25 (56.05 g) was added and stirring continued for 1 h. The mixture was cooled to 60° C. and the polymer was isolated in vacuo.

### Comparative Example 2—Preparation of HEUR with C₁₈-alkyl Hydrophobe

PEG 8000 (1318.5 g) was heated in vacuo and mixed at 110° C. in a batch melt reactor for 2 h. After the reactor was cooled to 90° C., butylated hydroxytoluene (BHT, 0.16 g) and Desmodur W (55.2 g) were added to the reactor, and the molten mixture was mixed for 5 min at 90° C. under N₂. Dibutyltin dilaurate (3.3 g) was added to the reactor and the reaction mixture was mixed for 10 min. n-Octadecanol (80.8 g) and methoxy polyethylene glycol (2000 g/mol, 237.4 g) were added to the reactor and stirring was continued for an additional 10 min at 90° C. The resulting molten polymer was removed from the reactor and cooled to room temperature. Prior to testing in the surfactant formulation, the polymer was dissolved in water with cyclodextrin to obtain an aqueous solution composed of 15 wt % polymer, 4 wt % cyclodextrin and 81% water.

### Comparative Example 3—Preparation of HEUR with C₁₀-alkyl Hydrophobe

PEG 8000 (1700.0 g) was heated to 110° C. in vacuo in a batch melt reactor for 2 h. After cooling the reactor contents to 90° C., BHT (0.18 g) and n-decanol (15.3 g) were added to the reactor and the reaction mixture was stirred for 5 min Desmodur W (94.6 g) was then added to the reactor with stirring for 5 min. Dibutyl tin dilaurate (4.25 g) was then added to the reactor and the resulting mixture was stirred for 10 min at 90° C. Subsequently, n-decanol (48.1 g) was added to the reactor and mixing continued for another 10 min at 90° C. The resulting molten polymer was removed from the reactor and cooled. This solid polymer was then dissolved in water to form a solution containing 35 wt % polymer, 38% propylene glycol and 27 wt % water.

Table 1 illustrates two detergent formulations prepared to test the efficacy of the HEURs. AE(9E0) is a lauryl alcohol ethoxylate with 9 ethylene oxide units per molecule (supplied as Emulgen 109P surfactant).

TABLE 1
Detergent Formulations

| | 2% Solids in | 3% Solids in |
|---|---|---|
| | 5% AE(9EO) | 15% AE(9EO) |
| Component | Wt % | Wt % |
| Deionized water | 93.0 | 82.0 |
| AE (9EO) surfactant | 5.0 | 15.0 |
| HEUR solids | 2.0 | 3.0 |

The Brookfield viscosity of formulations (mPas) was measured using RV spindles at 20 rpm after the formulation was equilibrated to 25° C. Clarity was measured subjectively by visual inspection. Table 2 illustrates the clarity and viscosity for each of the formulations. Viscosities of at least 400 mPas were considered acceptable.

TABLE 2
Viscosity and Clarity of Detergent Formulations with HEURs

| | 2% Solids in 5% | | 3% Solids | |
|---|---|---|---|---|
| | AE(9EO) | | in 15% AE(9EO) | |
| Example # | Clarity | Viscosity | Clarity | Viscosity (mPa · s) |
| Ex. 1 | Clear | 1,670 | Clear | 400 |
| Ex. 2 | Clear | 5,260 | Clear | 760 |
| Ex. 3 | Clear | 6,480 | Clear | 1,940 |
| Ex. 4 | Clear | 15,300 | Clear | 4,800 |
| Comp. 1 | Clear | 40 | Clear | 60 |
| Comp. 2 | Clear | <10 | ND | ND |
| Comp. 3 | Opaque | 128 | ND | ND |

Table 2 shows that Comparative Examples 2 and 3, which contain neither branching nor EO groups, are completely ineffective in increasing the viscosity of the lauryl alcohol ethoxylate aqueous solutions. Comparative Example 1, which has a long chain alkyl ethoxylate hydrophobe, but no branching, was also found to be ineffective. Only the HEURs with branching and long chain alkyl ethoxylate hydrophobes were effective as thickeners and gave clear solutions.

1. A composition comprising a waterborne hydrophobically modified alkylene oxide urethane thickener comprising structural units of a) a polyalkylene glycol; b) a polyisocyanate; and c) a C₁₄-C₃₀-alkyl-O—(CH₂CH₂O)ₙ—H alcohol ethoxylate capping agent; wherein n is from 1 to 40.

2. The composition of claim 1 wherein the hydrophobically modified alkylene oxide urethane thickener is a hydrophobically modified ethylene oxide urethane thickener, and wherein the polyalkylene glycol is a polyethylene glycol.

3. The composition of claim 2 wherein the polyisocyanate is a triisocyanate; and wherein n is from 5 to 35.

4. The composition of claim 1 wherein the mole-to-mole ratio of structural units of the polyisocyanate to the polyalkylene glycol is in the range of from 0.3 to 4.0; and wherein n is from 10 to 30.

5. The composition of claim 3 wherein the mole-to-mole ratio of structural units of the triisocyanate to the polyethylene glycol is in the range of from 0.5 to 3.0, and wherein the triisocyanate is IPDI isocyanurate trimer; HDI isocyanurate trimer; 1,3,5-triisocyanato-2-methylbenzene; or triphenylmethane-4, 4′, 4″-triisocyanate.

6. The composition of claim 5 wherein the C₁₄-C₃₀-alkyl-O—(CH₂CH₂O)ₙ—H alcohol ethoxylate capping agent is a C₁₆-C₂₈-alkyl-O—(CH₂CH₂O)ₙ—H alcohol ethoxylate, where n is range of from 16 to 30.

7. The composition of claim 6 wherein n is in the range of from 18 to 26.

8. The composition of claim 7 wherein the hydrophobically modified ethylene oxide urethane thickener further includes structural units of a diisocyanate.

9. The composition of claim 1 which further includes from 5 to 20 weight percent, based on the weight of the composition, of a cationic surfactant which is a quaternary ammonium salt, or a nonionic surfactant which is an amine oxide ethoxylate, a methyl ester ethoxylate, an alkyl amine alkoxylate, or a compound represented the formula: C₅-C₂O-alkyl-O—(CH₂CH₂O)ₚ—H, where p is in the range of from 5 to 25; wherein concentration of the hydrophobically modified ethylene oxide urethane thickener is in the range of from 0.5 to 5 weight percent, based on the weight of the composition.

10. The composition of claim 9 wherein the surfactant is a C₅-C₂O-alkyl-O—(CH₂CH₂O)ₚ—H nonionic surfactant, where p is in the range of from 7 to 11; wherein concentration of the hydrophobically modified ethylene oxide urethane thickener is in the range of from 1 to 3 weight percent, based on the weight of the composition.
